(19) United States
(12) Patent Application Publication
(10) Pub. No.: US 2016/0353674 A1
(43) Pub. Date: Dec. 8, 2016

(54) STACKABLE PLANTING SYSTEM LAYER QUARTER SECTION

(71) Applicant: John Rodney KEATS, NORTH LAMBTON (AU)

(72) Inventor: John Rodney KEATS, NORTH LAMBTON (AU)

(21) Appl. No.: 15/114,053

(22) PCT Filed: Jan. 21, 2015
(86) PCT No.: PCT/IB2015/000746

§ 371 Date: Jul. 25, 2016

(30) Foreign Application Priority Data
Jan. 24, 2014 (AU) 2014900216

(51) Int. Cl. A01G 9/02; B65D 21/04; B65D 21/02; A01G 27/00; A01G 31/06

(52) U.S. Cl. CPC A01G 9/028; A01G 9/023; A01G 27/003; A01G 31/06; A01G 27/008; B65D 21/0204; B65D 21/046

(57) ABSTRACT

A plant container is provided that is configured to form an attachable/detachable quarter section of a 360° stackable planting system layer that can be stacked on the offset with identical engaged and coupled quarter sections forming stackable planting system layers and jointly may be further suspended in a hanging position. Said quarter section engaged and coupled with two identical quarter sections forms a 270° radially aligned Post or external corner mounted or stacked and mounted Planter. The quarter section engaged and coupled with one identical quarter section forms a 180° radially aligned wall mounted or stacked and mounted planter or singularly offers a plant container suited to mount within the confines of a 90° corner of two converging walls.

### FIELD OF THE INVENTION

The present invention relates to a plant container that forms an attachable/detachable quarter section of a 360° stackable planting system layer. Said quarter section engaged and coupled with two identical quarter sections forms a 270° radially aligned Post or external corner mounted or stacked and mounted Planter. The quarter section engaged and coupled with one identical quarter section forms a 180° radially aligned wall mounted or stacked and mounted planter or singularly offers a plant container suited to mount within the confines of a 90° corner of two converging walls.

### BACKGROUND OF THE INVENTION

Various forms of plant pots are known for growing plants. Typical plant pots are either of generally cylindrical, frustoconical or rectangular prism form. Frustoconical type plant pots are advantageous over cylindrical or rectangular prism type pots in that they are often able to be located at least partially within each other for transport, storage and display, thereby realising considerable space savings. Generally, they cannot, however, be stacked on top of each other in any suitable manner for use.

Many pot plant enthusiasts like to arrange several pots in a generally vertical relationship for particular aesthetic appeal and saving of space. Such an arrangement currently typically depends on use of a separate stand to mount the pots or hanging of one pot from another with chains or the like.

Several attempts have been made to provide stackable plant pots. One such attempt is disclosed in Australian patent No.634522 in the name of Gromax Systems, Inc. This patent discloses a multiplicity of plant pots having an essentially square-shaped cross section. The plant pots can be stacked one on top of another by having each plant pot rotated approximately 450 about a common axis relative to an adjacent plant pot. The adjacent plant pots are seated one on top of the other, thereby requiring that the individual plant pots (Particularly those located towards the bottom) are particularly strong and rigid.

This arrangement provides only a very small useable area for growing plants, namely, the small corner portions which protrude beyond the pot immediately above. Also, this arrangement of plant pots is not adapted to be hung or suspended.

Australian patent No.586493, in the name of Stephen Fraknoi, also discloses an arrangement of stacked plant pots. Each pot is adapted to be seated upon a pot located immediately beneath it. In order to support the weight of a series of stacked pots, each individual pot must be particularly strong so that pots near the base of the arrangement are not squashed or deformed. Also, the particular design and construction of each individual pot is quite complex and it would be difficult and expensive to manufacture. This particular arrangement of plant pots is also not adapted to be hung or suspended.

European patent No.0 142 471, in the name of Werner Gerber, discloses a plant pot adapted to be stacked one on top of another. The plant pot of this disclosure is relatively flimsy and the stacking of three or more plant pots (especially if they contain soil) is likely to cause the lower pots in the arrangement to collapse or deform. The pots of this disclosure have connecting means comprising protruding tabs extending from an upper rim of each pot for insertion in a corresponding slot in a base of an adjoining pot. This arrangement for connecting adjacent pots is awkward for a user, given the relatively small sizes of the corresponding protrusions and slots. The arrangement also provides no added strength to the arrangement of pots. In all of the plant pots described above, the means for securing one pot on top of another is very flimsy and/or quite difficult to align. The weight imposed on a pot by a series of pots stacked above it can be substantial and can cause a degree of compression which may be sufficient to break the securing means and break or deform the lower pot(s). In the context of this specification the term “stackable” means able to be arranged on top of one another.

Australian Patent of John Keats Pat. No. 726469 discloses a stackable plant pot that singularly forms a layer of a stackable planting system that can be hung and his U.S. Pat. No. 7,730667 B2 discloses a similar plant pot that provides a self-watering feature and hydroponics application. Mr. Keats also discloses a wall mounted stackable plant pot PCT/AU2009/000847 that has a 180° radial alignment.

However none of the above stackable planting systems allow for the stackable planting system layers to become segmented and detachable to provide a plant pot container that can perform the tasks of all types of plant pots whether in its singular form or an attached plurality.

### OBJECT OF THE INVENTION

The present invention is directed to ameliorating the abovementioned. Restrictions and, in particular, to providing a corner wall plant pot that singularly can be mounted snuggly within the confines of a 90% corner of two converging walls forming a right angle, and by attaching an identical segment the container transforms into a wall planter with a 180° alignment, that may be stacked and mounted, an outward projecting corner wall planter or post mounted planter, an outward projecting corner wall planter or post mounted planter that may be also stacked, the same configuration may also be free standing offering a stackable planter with a 270° radial alignment and position flat against a wall and configurable to form a stackable planting system layer which is capable of holding plants and being simultaneously stacked on top of another substantially identically configured stackable planting system layer holding plants.

The invention is further intended to provide a stackable planting system layer which can be stacked with two or more other stackable planting system layers in a stable arrangement, such that the addition of several stackable planting system layers does not substantially adversely affect the shape of the lower pots in the stack or the stability of the stack. The invention is also directed to providing a plurality of attached segments forming a stackable planting system which in use can be suspended by a chain, cord or rod and or the whole system can be irrigated through a channel formed at the epicentre of the fully engaged and attached segments that form the stackable planting system layers.

### SUMMARY OF THE INVENTION

The invention relates to a plant pot which, in use, is adapted to be attachable and detachable and may be stacked with one or more other similar configurations, wherein: each individual plant pot forms a section of either a coupled pair, trio or four identical attachable/detachable quarter sections to form a coupled layer of a stackable planting system and shall be known hereafter as quarter section plant pots or just quarter sections each having a base section, an outwardly projecting or lobed front wall/s and two side walls intersecting at a right angle all forming a cavity or container for the purpose of growing plants which in use the individual sections may be positioned singularly detached from each other and mounted snugly within a corner where two vertical surfaces intersect at an inward converging right angle, with the side walls of each said quarter section pot fashioned in such a manner as to alternatively allow two quarter section pots to interlock and bond securely together by any means suitable forming a whole larger plant container having an extended back wall, two outwardly projecting walls or lobed sections each with base sections and two upper cavities with a side wall of each coupled quarter section pot interconnecting forming a central partitioned wall of that union and in so doing converts the two corner wall mountable split quarter section pots into a whole flat backed wall planter configuration that can to be mounted and or stacked on the offset with other sections and coupled sections and jointly mounted within a 180° radial alignment onto any vertical surface.

The quarter sections may a further interlock with one of a coupled two quarter section pots allowing a formation that can be mounted and or stacked on the offset with other quarter sections and coupled quarter sections and either positioned free standing against a wall or jointly mounted onto a post or outward projecting right angled corner within a 270° radial alignment.

Two quarter sections coupled and interlocked forming the said flat backed wall planter configuration may further interlock back to back with an identically configured flat backed wall planter to form a 360° arrangement comprising 4 quarter sections resembling a single partitioned layer of a 4 lobed stackable plant pot and in fact can be stacked on the offset with any number of other identical configurations forming a free standing stackable planting system.

The quarter sections singularly detached can substantially nest within each other without interference to conserve storage and transport costs and may be promoted, marketed and sold singularly as a single corner wall planter or as an attachable/detachable add on pot to an already coupled system of multiple quarter section pots.

A preferred embodiment of said quarter section has a base section with drainage overflow holes passing through the base section side walls, an outwardly projecting or lobed front wall/s with an upper lip section and two side walls intersecting at a right angle all forming a cavity or container for the purpose of growing plants with each side wall supporting a series of outwardly extending tabs and tab receiving bays or cut outs adjacent to the pots upper edge fashioned to except a corresponding series of tabs and side wall tab receiving bays or cut outs in an interlocking manner of those of an identical quarter section pot of the preferred embodiment.

This preferred embodiment has an (A) side wall and a (B) side wall with (A) side wall tabs directed downwards (B) side wall tab receiving bays or cut outs directing upward or a combination of up and down on each side wall in a corresponding manner so as when (A) side wall tabs of one quarter section lock into (B) the tab receiving bays or cut outs of another quarter section and vice versa and when both side walls are forced in different directions upward or downward the two corresponding side walls of each quarter section interlock and form a secure bond adjacent to their upper edge.

The base of a preferred embodiment has an outwardly projecting or lobed front wall, two side walls and intersecting at a right angle and a recessed bottom wall that is fitted with a with a slide bolt action hooked locking mechanism passing through and held firmly in place by the bottom recessed wall with said locking mechanism fashioned with a pair of elongated hooked barbs and an opposing locking mechanism receiver formed to interlock with said hooked barbs allowing the slide bolt action hooked locking mechanism to engage with an opposing locking mechanism receiver located on the bottom wall adjacent to the bottom edge of side wall of an identical quarter section providing an extremely secure bond between both quarter section side walls top and bottom when all corresponding tabs, side wall tab receiving bays or cut outs and said locking mechanism/receiver are fully engaged.

In addition the recessed bottom wall of the said base section on the preferred embodiment is provided with a centrally located and further recessed channel extending from the front region of the recessed bottom wall back to the rear intersection of the side walls and running between the slide bolt action hooked locking mechanism adjacent to side and the corresponding locking mechanism receiver adjacent to side on the preferred embodiment of the quarter section, with said channel fashioned to saddle over and seat securely upon the upper edge of a quarter section or the upper edges of the engaged side walls of two quarter sections when positioning on the offset and producing a stacked formation of quarter sections The point of intersection of the side walls forming a right angle on a preferred embodiment of a quarter section is modified to form a profiled channel running from the top edge of the intersecting sidewalls down the entire spine of the said intersection to the base section which will enable the formation of a tube like passage when all four quarter sections of said plant pots are arranged and engaged into a 360° radial alignment allowing the user to pass an elongated body through or fixture within the formation when in the coupled and or stacked formation, and such elongated bodies may include chain, rope, rod, supports, irrigation tubing, irrigation equipment and/or any such device that will aid in the preservation and wellbeing of the plants contained within the plant pots.

The recessed base section can be fitted with a moisture retention device or water retention material which may incorporate any of the following: Super Absorbing Polymers, Perlite, Vermiculite, Zeolite, Coir, Sphagnum Moss, Sponge or any moisture retentive compound or mineral suitable for the task.

In another preferred embodiment the base section may form a water storage reservoir that is separated from a soil holding region by means of a separation plate or perforated grid with excess drainage holes located above the uppermost tidal line of the water reservoir.

The separation plate or perforated grid has downward formed perforated depressions that well down into the water reservoir extending the soil holding region within the perforated depressions and allowing water to enter the soil holding region but preventing the soil from entering the water reservoir region providing a self-watering effect on the soil holding region via the soils own capillary action on the fluid seepage through the perforations in these downward depressions.

In yet another preferred embodiment the water reservoir and separation plate are separate parts forming their own separate container and are removable from the quarter section pot giving the user the choice of a self-watering option or a free draining option.

A coupled and or stacked formation of said quarter section pots may be provided with a support means in the form of a drainage overflow tray or saucer positioned under the lowermost pots of a coupled and or stacked formation with said tray or saucer having a raised centrally located opening allowing said elongated bodies to pass through from below its bottom surface while being shielded from any excess drainage held within the saucer. The coupled and or Stacked formation may be further provided with a I and seats over and upon a water or solution catchment tank or its drainage or feeding channels to facilitate an integrated hydroponics or aquaponics system incorporating mains powered, rechargeable battery powered and or solar assisted powered parts e.g. pump, timer oxygenator etc. This water solution catchment tank or larger support means is a water storing plant growing container/s stand combination drainage tray modified to securely house and position a battery powered or assisted submersible pump or submersible pump with a perpetual movement or solar powered submersible pump within its reservoir area, comprising a bottom wall and a side wall/s and an opened cavity forming catchment tank that includes overflow drainage outlets passing through the said side wall/s at its upper region with both bottom and side walls supporting a water drainage tray spanning across its upper opening of its cavity and resting upon its upper edge, lip or step/s immediately above and adjacent to said side wall overflow drainage outlets and when in use provides a water storing self-reticulating watering system irrigating said supported plant growing container/s operating independently in any location without the requirement of mains power

### BRIEF DESCRIPTION OF THE DRAWINGS

Preferred forms of the present invention will now be described by way of example with reference to the accompanying drawings:

FIG. 1 Top View;

FIG. 2 Bottom View;

FIG. 3 Side View (A);

FIG. 4 Side View (B);

FIG. 5 Back View;

FIG. 6 Perspective View;

FIG. 7 Slide bolt action hooked locking mechanism;

FIG. 8 Bottom Perspective View;

FIG. 9 Sectional Bottom perspective View;

FIG. 10 Coupled Quarter Sections Perspective View;

FIG. 11 Engaged 4 quarter Sections Perspective View;

FIG. 12 Engaged 4 quarter Sections Stacked on offset Perspective View;

FIG. 13 Quarter sections Mounted in a 90% corner;

FIG. 14 Coupled Quarter Sections mounted on a 180% vertical surface;

FIG. 15 Three coupled Quarter Sections mounted on an external corner or post;

FIG. 16 Three coupled Quarter Sections mounted and stacked on an external corner or post;

FIG. 17 Engaged quarter Sections stacked flat against wall Perspective View;

FIG. 18 Engaged 4 quarter Sections Stacked on offset with tray Perspective View;

FIG. 19 Engaged 4 quarter Sections Stacked on offset with tray and larger support means Perspective View;

FIG. 20 Quarter Sections in storage mode Perspective View;

FIG. 21 Alternative Embodiment Pot Top View;

FIG. 22 Alternative Embodiment Pot Bottom view;

FIG. 23 Alternative Embodiment Pot Perspective views left and right;

FIG. 24 Alternative Embodiment Pot Internal separating plate Top and Perspective views;

FIG. 25 Alternative Embodiment Pot Locking Mechanism top, side and perspective views;

FIG. 26 Embodiment of a Quarter section pot insert;

FIG. 27 Alternative Larger Support Means Embodiments Lid top with solar power pack, Tank top, Side view of Lid with fitted solar power pack and side view of Tank;

FIG. 28 Alternative Embodiment of larger support means assembled with solar power pack fitted perspective view;

FIG. 29 Stacked formation with Inserts and Water Storing larger Supporting means perspective view; and

FIG. 30 Perspective view of the Water Storing larger Supporting means Tank with internal support pillar, pump, irrigation tubing and an irrigation head.

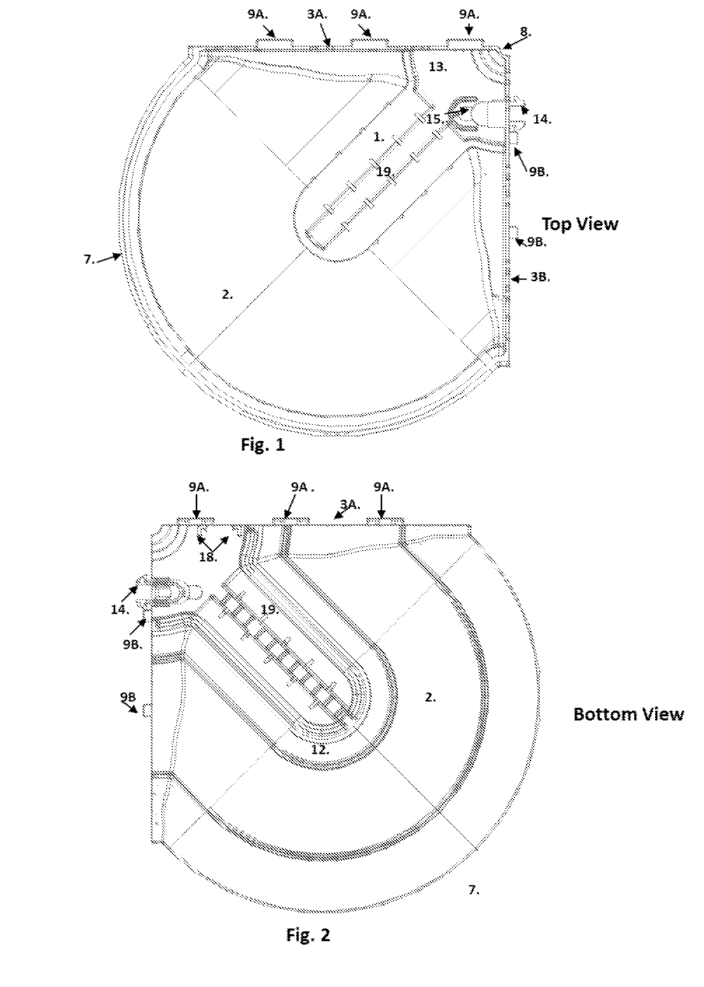

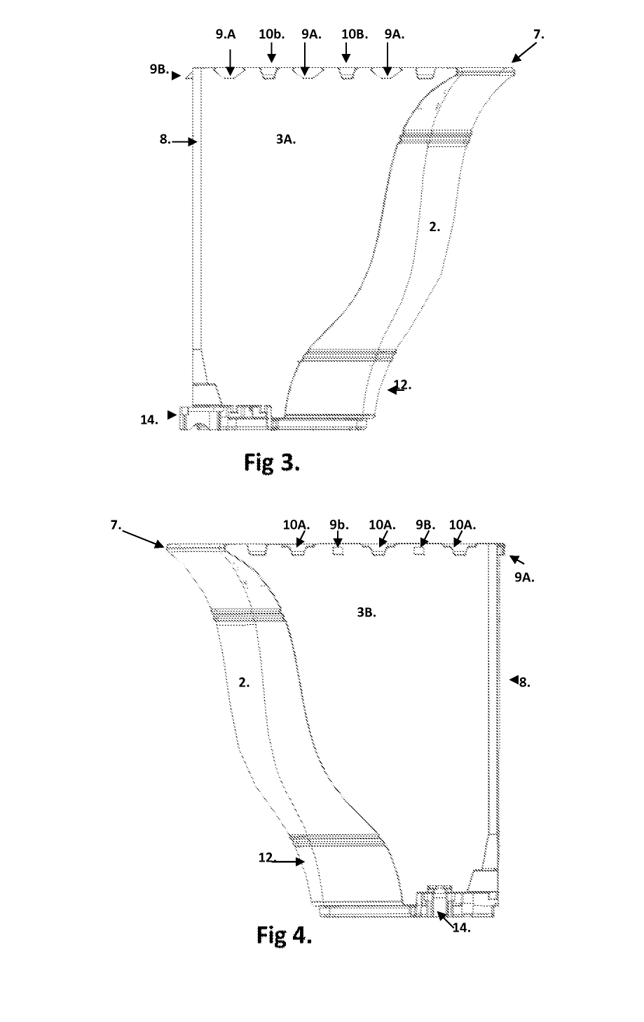

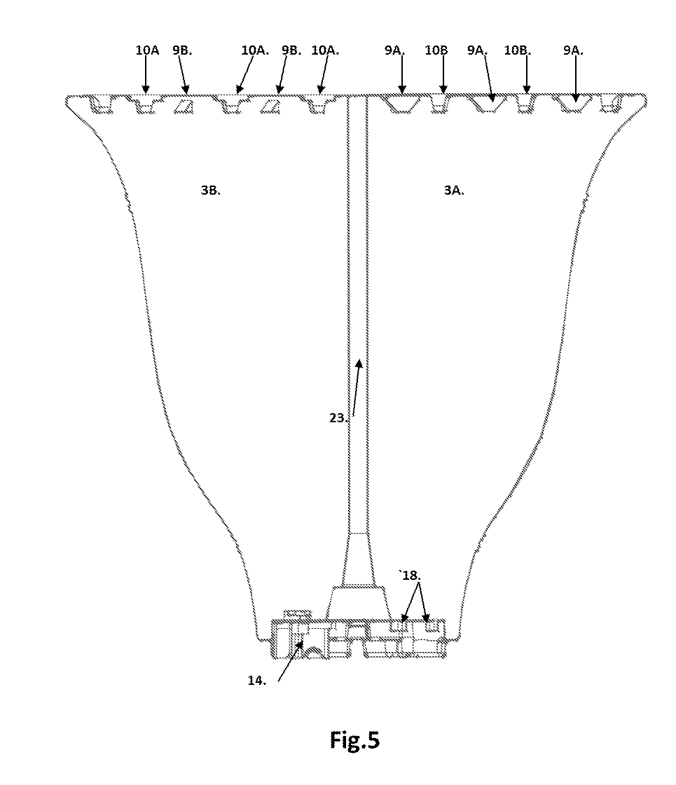

### DETAILED DESCRIPTION OF THE DRAWINGS

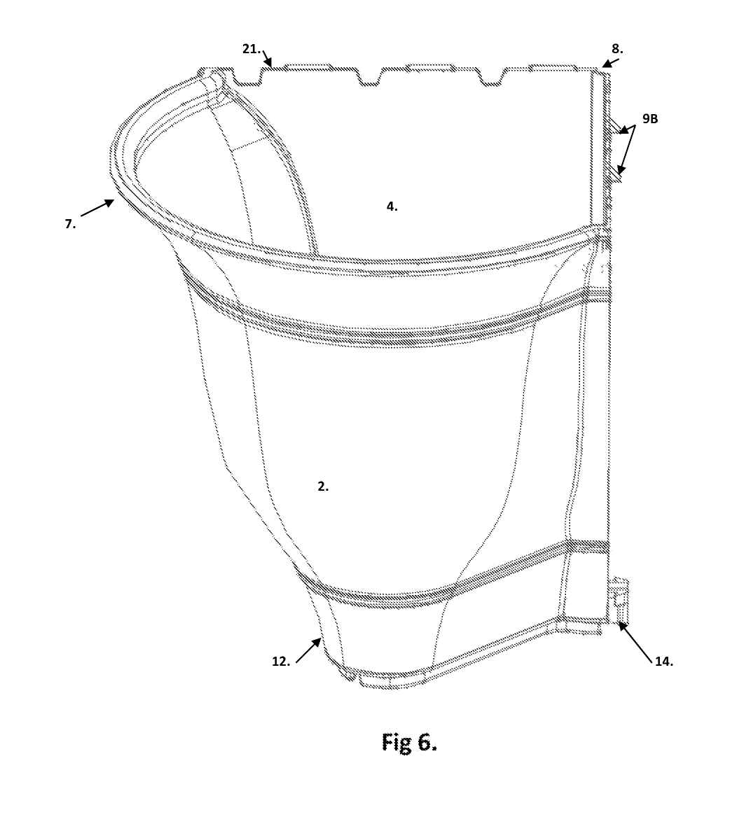

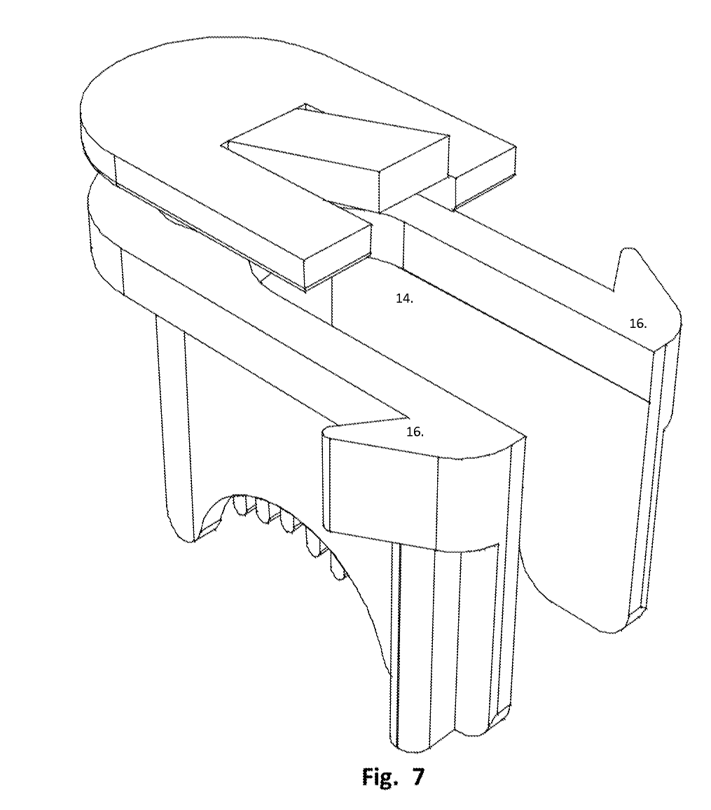

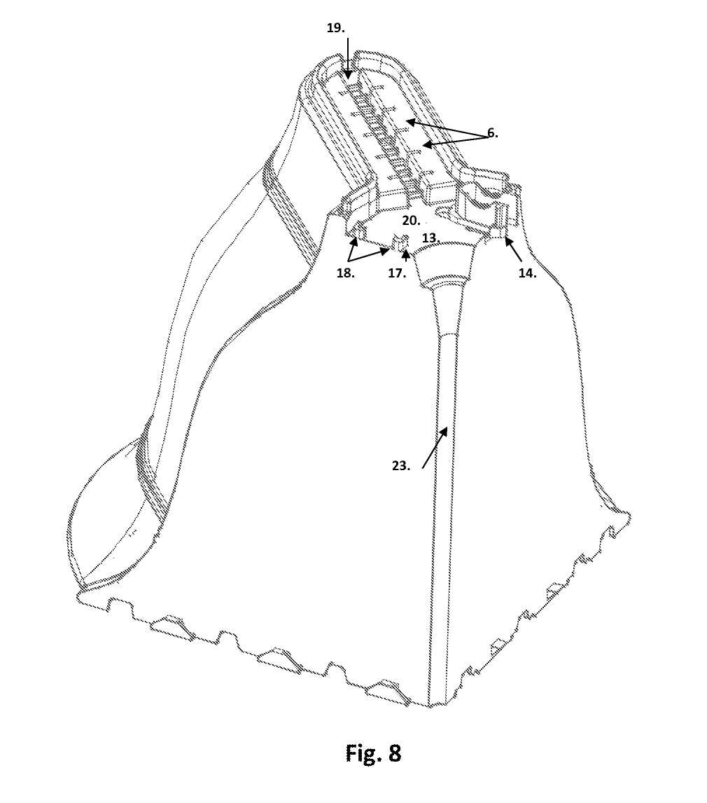

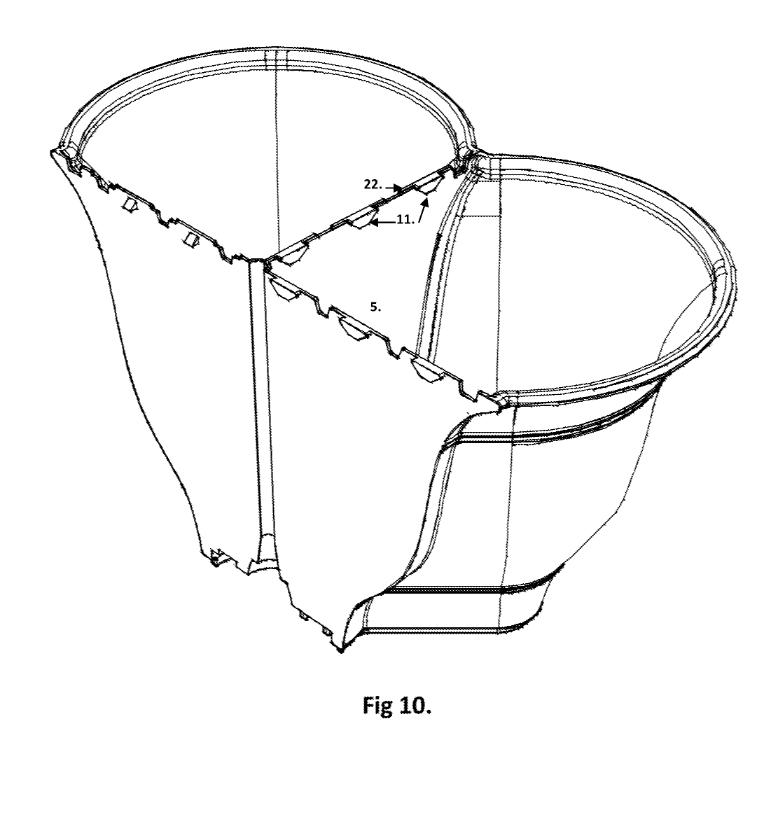

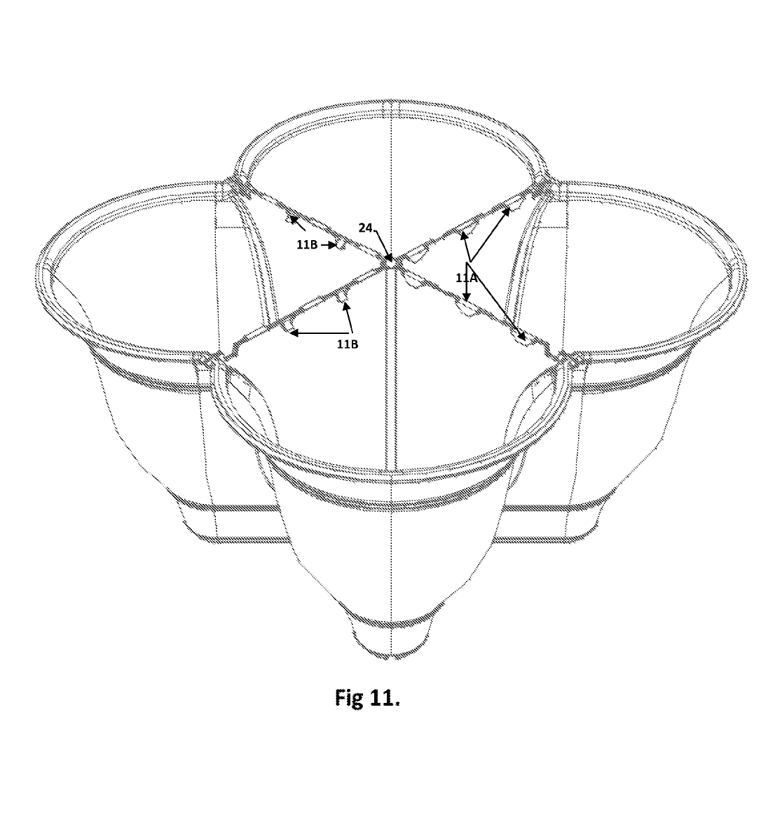

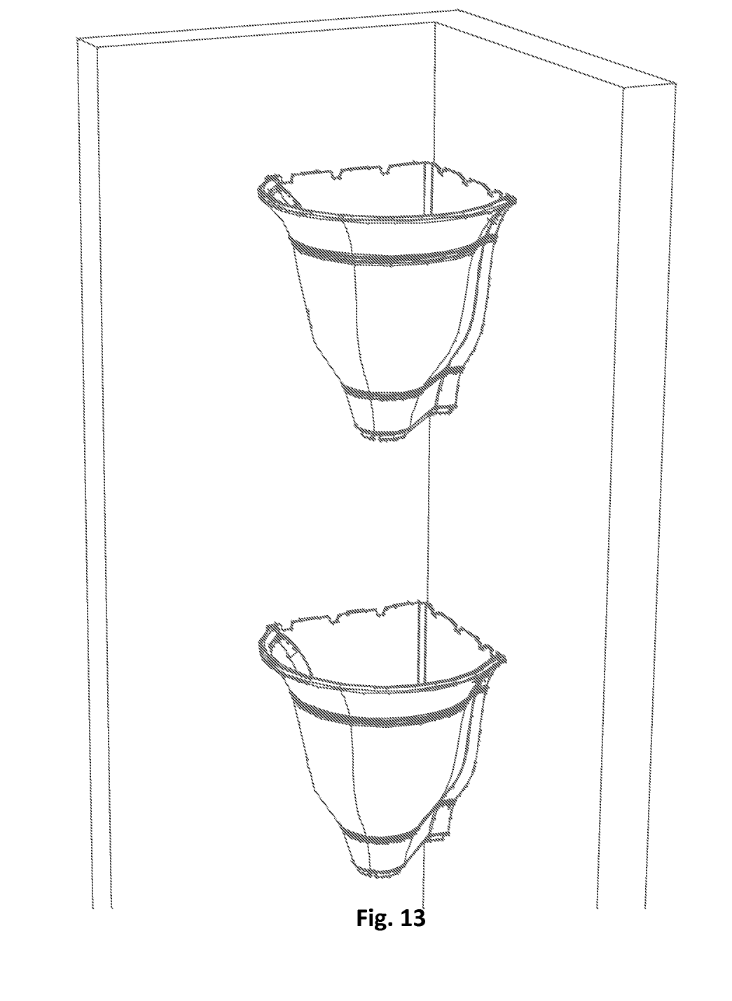

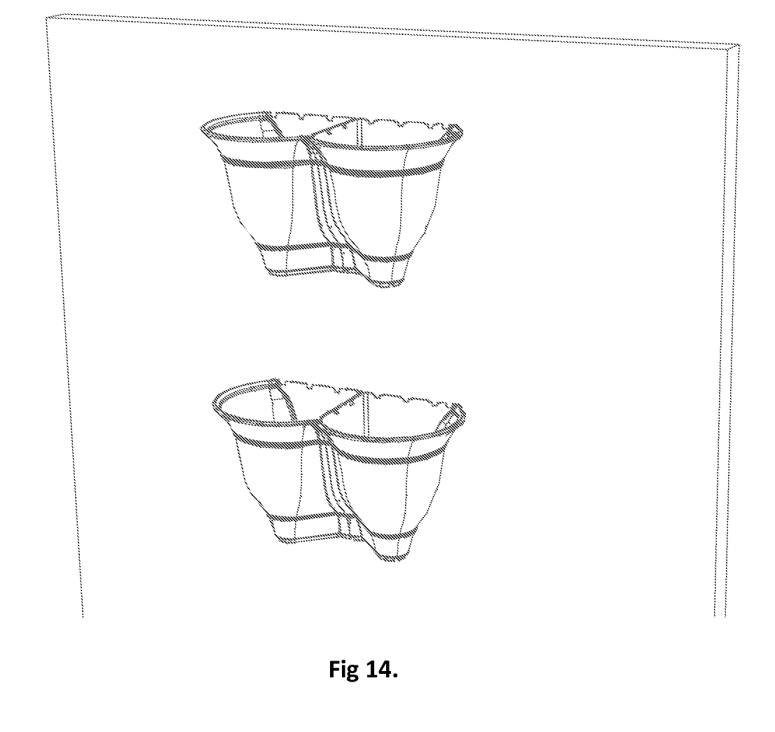

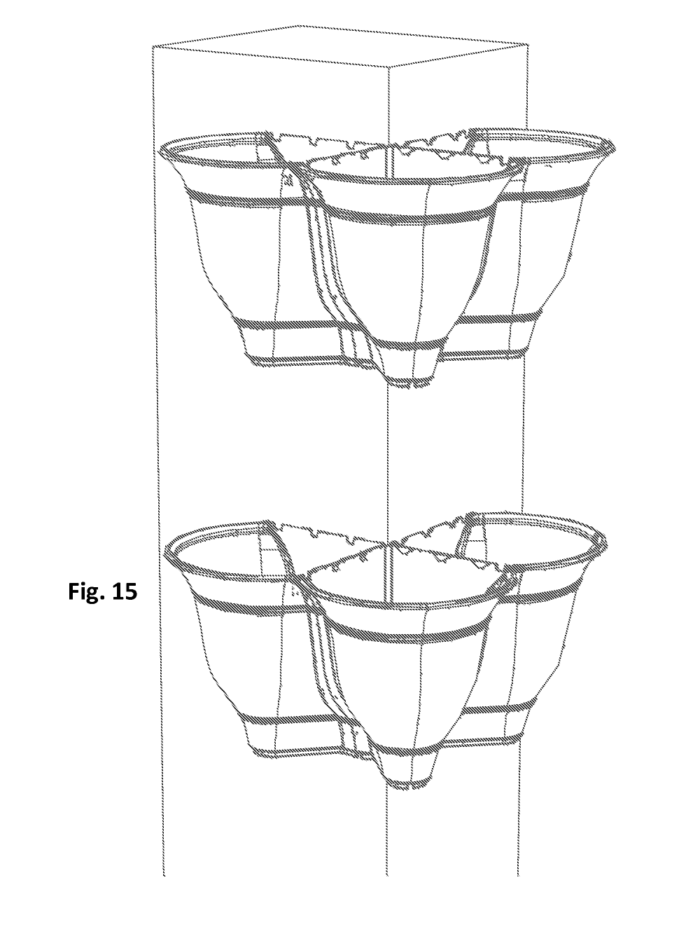

According to this invention there is provided a plant pot which, in use, is adapted to be attachable and detachable and may be stacked with one or more other similar configurations, wherein: each individual plant pot that forms a section of either a coupled pair FIG. 10, trio as depicted in FIG. 15 or four identical attachable/detachable quarter sections to form a coupled layer of a stackable planting system FIG. 11 and shall be known hereafter as quarter section plant pots or just quarter sections see in FIG. 6 each having a base section (1.), an outwardly projecting or lobed front wall/s (2.) and two side walls intersecting at a right angle (3A). and (3B.) all forming a cavity (4.) or container for the purpose of growing plants which in use the individual sections may be positioned singularly detached from each other and mounted snugly within a corner where two vertical surfaces intersect at an inward converging right angle FIG. 13, with the side walls of each said quarter section pot fashioned in such a manner as to alternatively allow two quarter section pots to interlock and bond securely together by any means suitable forming a whole larger plant container having an extended back wall, two outwardly projecting walls or lobed sections each with base sections and two upper cavities with a side wall of each coupled quarter section pot interconnecting forming a central partitioned wall FIG. 10 (5.) of that union and in so doing converts the two corner wall mountable split quarter section pots into a whole flat backed wall planter configuration that can to be mounted and or stacked on the offset with other sections FIG. 14 and coupled sections and jointly mounted within a 180° radial alignment onto any vertical surface.

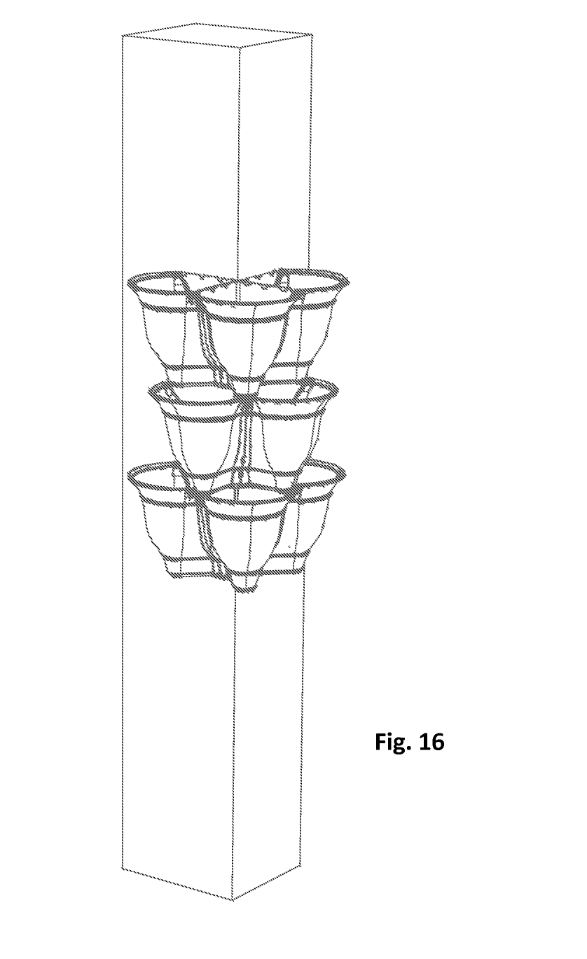

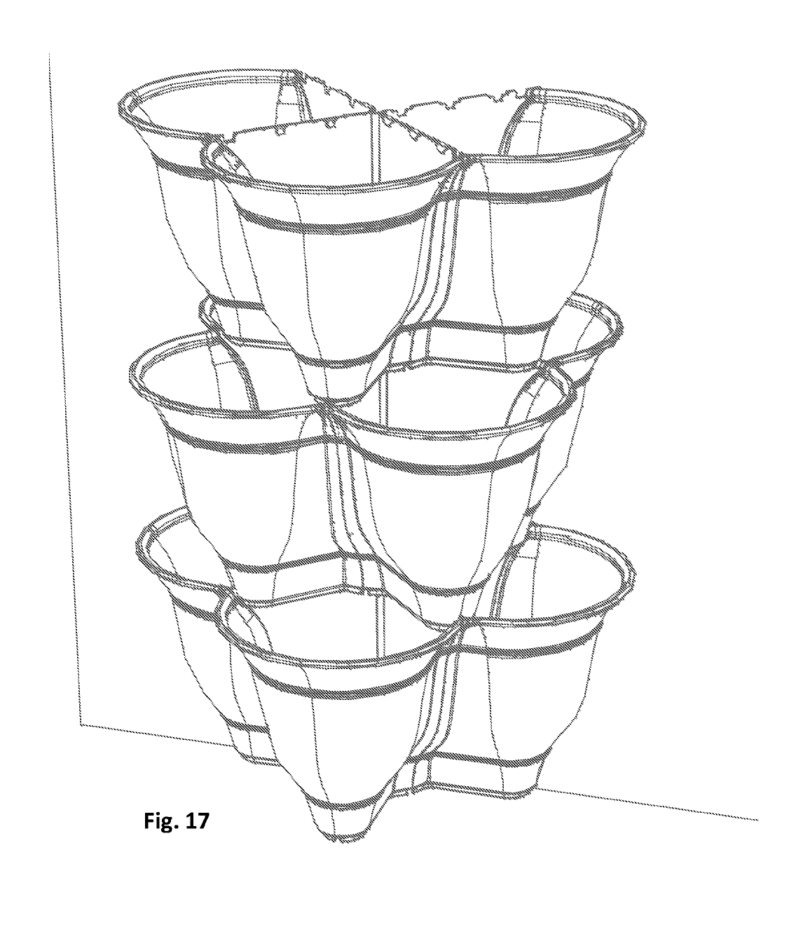

The quarter sections may further interlock with one or a coupled two quarter section pots allowing a formation that can be mounted and or stacked on the offset with other quarter sections and coupled quarter sections and either positioned free standing FIG. 17 against a wall or jointly mounted onto a post or outward projecting right angled corner within a 270° radial alignment see FIGS. 15 and 16.

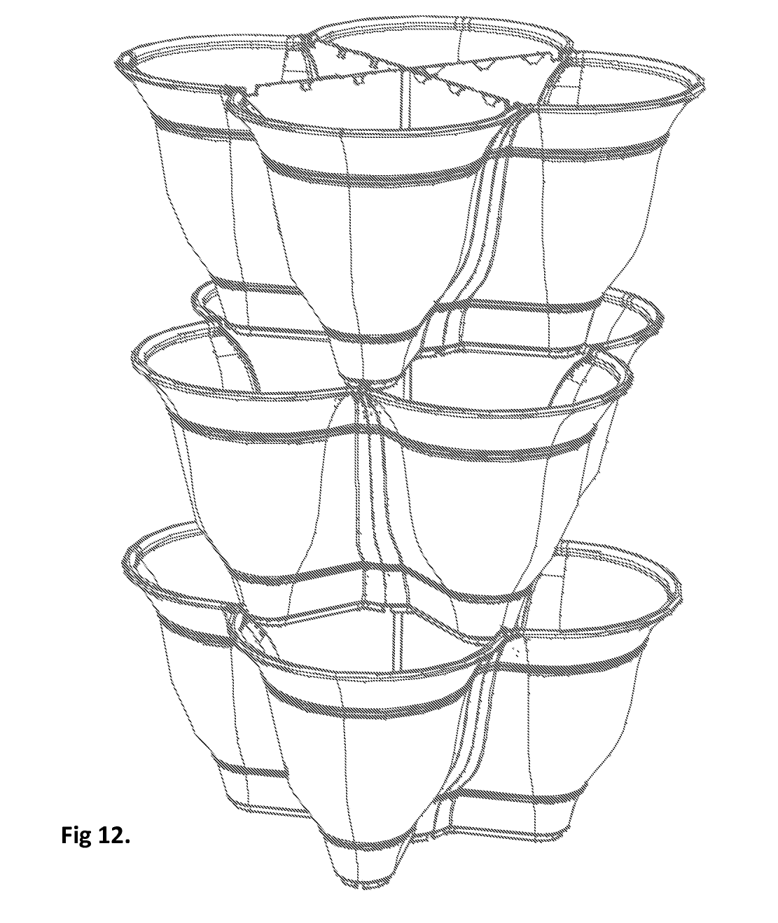

Two quarter sections coupled and interlocked forming the said flat backed wall planter FIG. 10 configuration may further interlock back to back with an identically configured flat backed wall planter to form a 360° arrangement comprising 4 quarter sections resembling a single partitioned layer of a 4 lobed stackable plant pot FIG. 11 and in fact can be stacked on the offset with any number of other identical configurations forming a free standing stackable planting system FIG. 12.

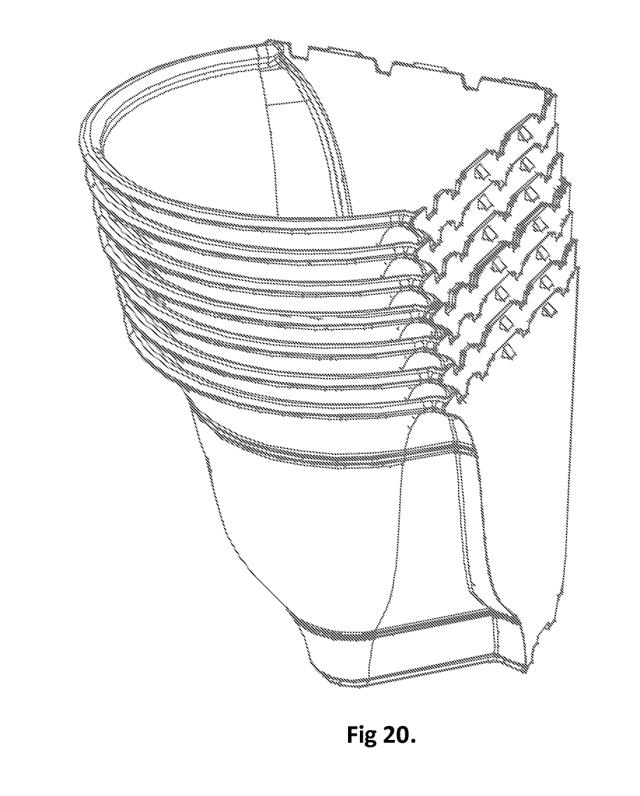

The quarter sections singularly detached can substantially nest within each other FIG. 20 without interference to conserve storage and transport costs and may be promoted, marketed and sold singularly as a single corner wall planter FIG. 6 or as an attachable/detachable add on pot to an already coupled system of multiple quarter section pots.

A preferred embodiment of said quarter section has a base section (1.) with drainage overflow holes passing through the base section side walls (6.) FIG. 6, an outwardly projecting or lobed front wall/s (2.) with an upper lip section (7.) and two side walls shown in FIG. 5 as 3A. and 3B. intersecting at a right angle (8.) all forming a cavity (4.) or container for the purpose of growing plants with each side wall supporting a series of outwardly extending tabs (9.) and tab receiving bays or cut outs (10.) adjacent to the pots upper edge fashioned to except a corresponding series of tabs and side wall tab receiving bays or cut outs in an interlocking manner of those of an identical quarter section pot of the preferred embodiment.

This preferred embodiment has an (A)side wall (3A.) and a (B) side wall (3B.), with (A) side wall tabs directed downwards (B) side wall tab receiving bays or cut outs directing upward or a combination of up and down on each side wall in a corresponding manner so as when (A) side wall tabs of one quarter section lock into (B) the tab receiving bays or cut outs of another quarter section and vice versa and when both side walls are forced in different directions upward or downward the two corresponding side walls of each quarter section interlock and form a secure bond adjacent to their upper edge.(11.) FIG. 10.

The base of a preferred embodiment (1.) has an outwardly projecting or lobed front wall, (12.) two side walls (3.A) and (3.B) intersecting at a right angle (8.)and a recessed bottom wall (13.) that is fitted with a with a slide bolt action hooked locking mechanism (14.) passing through and held firmly in place by the bottom recessed wall (15.) with said locking mechanism fashioned with a pair of elongated hooked barbs (16) FIG. 7 and an opposing locking mechanism receiver formed to interlock with said hooked barbs (3.B) allowing the slide bolt action hooked locking mechanism to engage with an opposing locking mechanism receiver (18.) located on the bottom wall adjacent to the bottom edge of side wall (3.A) of an identical quarter section providing an extremely secure bond between both quarter section side walls top and bottom when all corresponding tabs, side wall tab receiving bays or cut outs and said locking mechanism/receiver are fully engaged.

In addition the recessed bottom wall (13.) of the said base section (1.) on the preferred embodiment is provided with a centrally located and further recessed channel (19.) extending from the front region (12.) of the recessed bottom wall back to the rear intersection of the side walls (20.) and running between the slide bolt action hooked locking mechanism (14.) adjacent to side (3B) and the corresponding locking mechanism receiver adjacent to side (3A) on the preferred embodiment of the quarter section, with said channel fashioned to saddle over and seat securely upon the upper edge of a quarter section(21.) or the upper edges of the engaged side walls of two quarter sections (22.) when positioning on the offset and producing a stacked formation of quarter sections FIG. 12.

The point of intersection of the side walls forming a right angle on a preferred embodiment of a quarter section is modified to form a quadrant profiled channel (23.) running from the top edge (21.) of the intersecting sidewalls (8.) down the entire spine of the said intersection to the base section which will enable the formation of a tube like passage (24.) when all four quarter sections of said plant pots are arranged and engaged into a 360° radial alignment allowing the user to pass an elongated body through or fixture within the formation when in the coupled and or stacked formation, and such elongated bodies may include chain, rope, rod, supports, irrigation tubing, irrigation equipment and/or any such device that will aid in the preservation and wellbeing of the plants contained within the plant pots.

The internal recessed base section (1.) can be fitted with a moisture retention device or water retention material which may incorporate any of the following: Super Absorbing Polymers, Perlite, Vermiculite, Zeolite, Coir, Sphagnum Moss, Sponge or any moisture retentive compound or mineral suitable for the task.

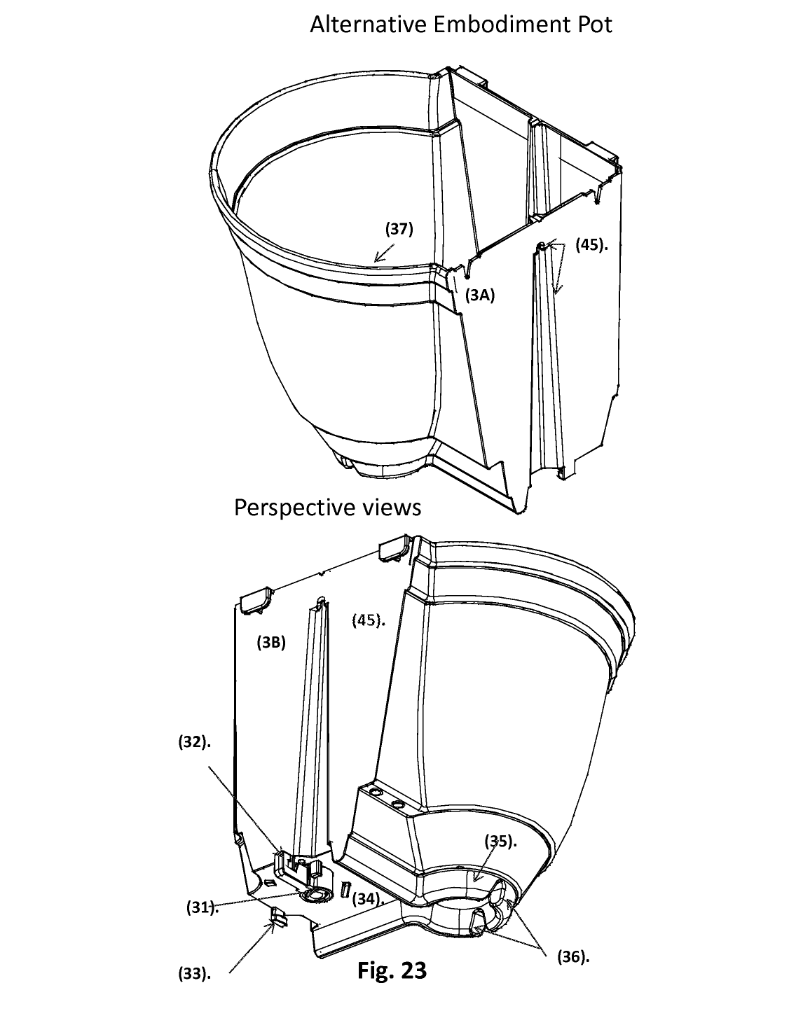

An alternative Pot embodiment FIG. 23 may be fitted with a different locking mechanism that allows a water tight water reservoir region (30). in the lower section of the quarter section pots: whereas said locking mechanism FIG. 25/(32). is attached to a protrusion (31). on the base in a lock on manner however allowing the locking mechanism to rotate outwardly and engage with a locking mechanism receiver FIG. 23/(33). aligned on an adjoining quarter section pot.

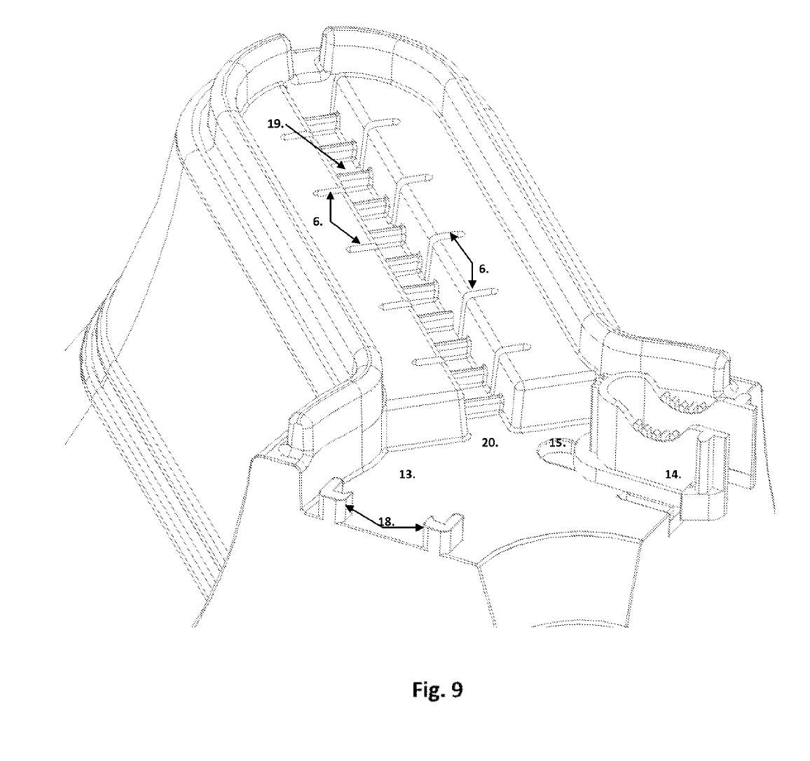

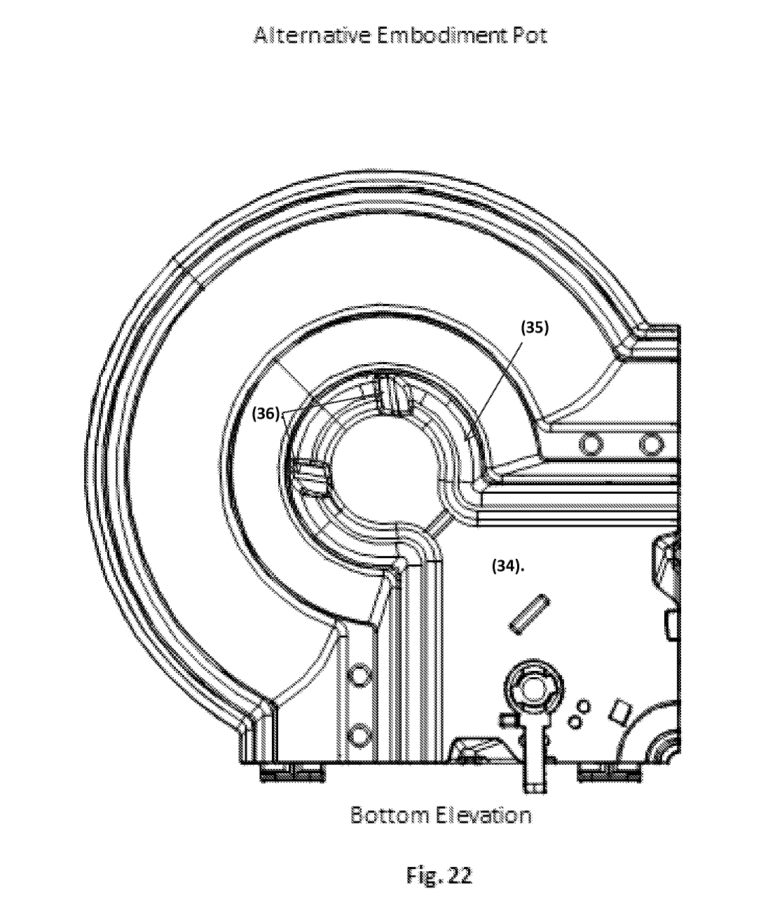

The base section of this altered pot embodiment is reconfigured to allow a different seating connection when the quarter section pots are grouped and in the stacked formation whereas; the centrally located and further recessed channel extending from the front region of the recessed bottom wall back referred to in claim 9 FIG. 9/(19) has given way to a reconfigured fully recessed bottom wall FIG. 22 (34) forming an extended downwardly protruding lip (35) on the lobed front wall that further comprises two bridged sections, notches or cut outs (36) configured to seat over and securely hold onto the upper lobed lip or lips (37). of quarter section pots position immediately below when seated in the stacked formation.

The same embodiment with side walls (3A) and (3B) shown in FIG. 23 have a singular or a plurality of channels and overhangs (45) to accept and engage in fastening equipment Screws, Brackets etc. for the purpose of mounting the quarter section pot or coupled quarter sections upon any vertical surface.

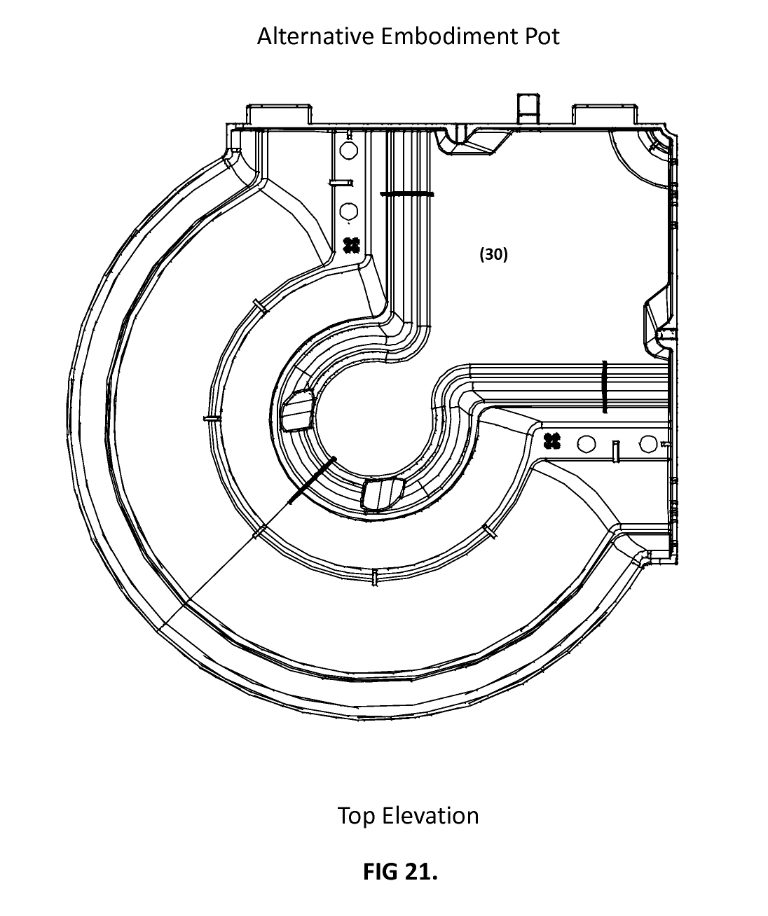

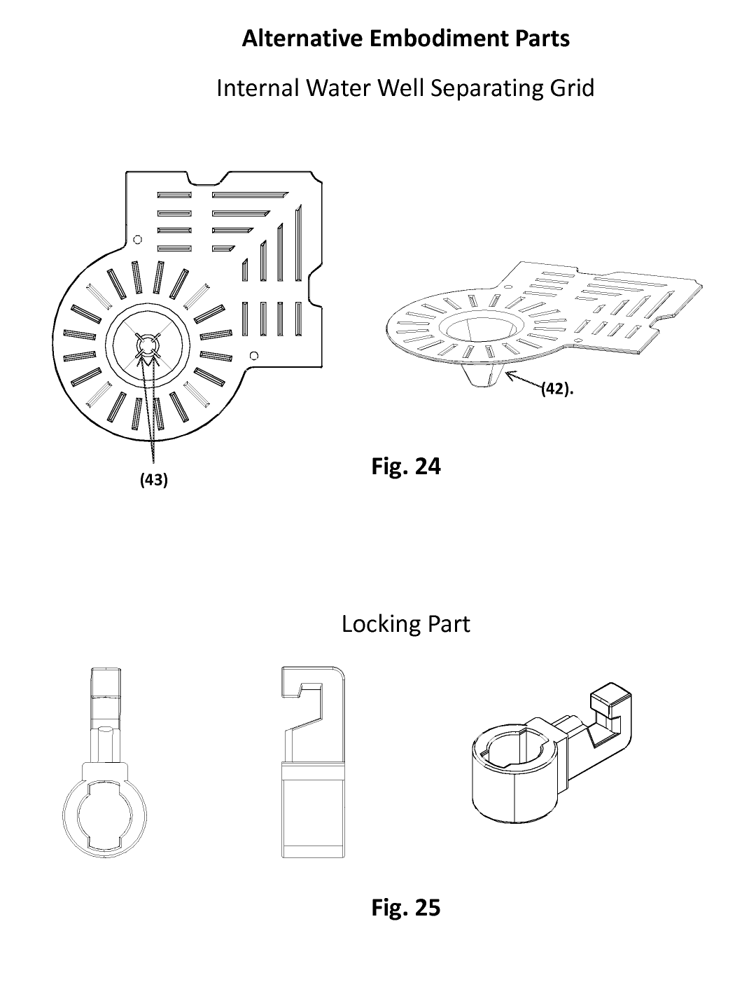

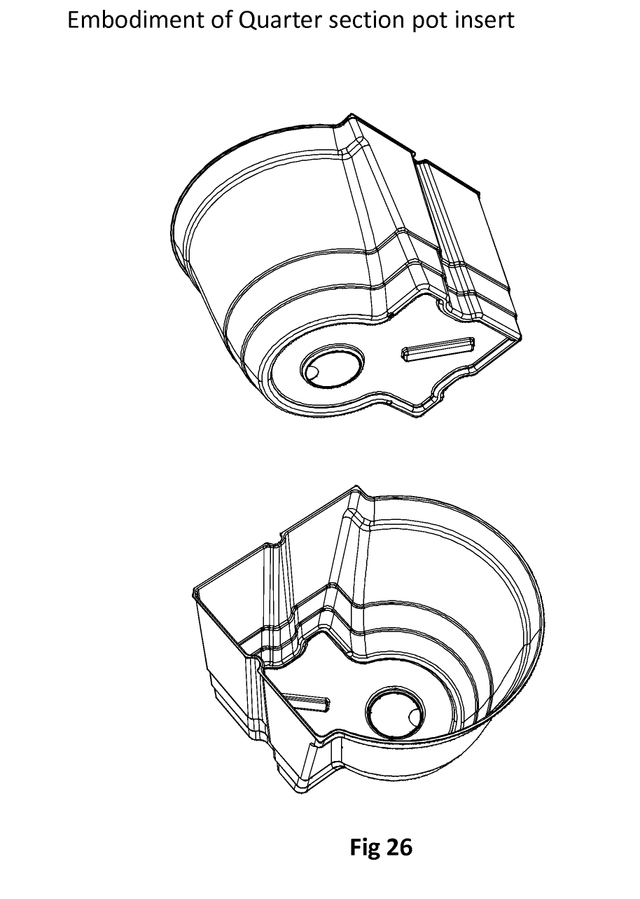

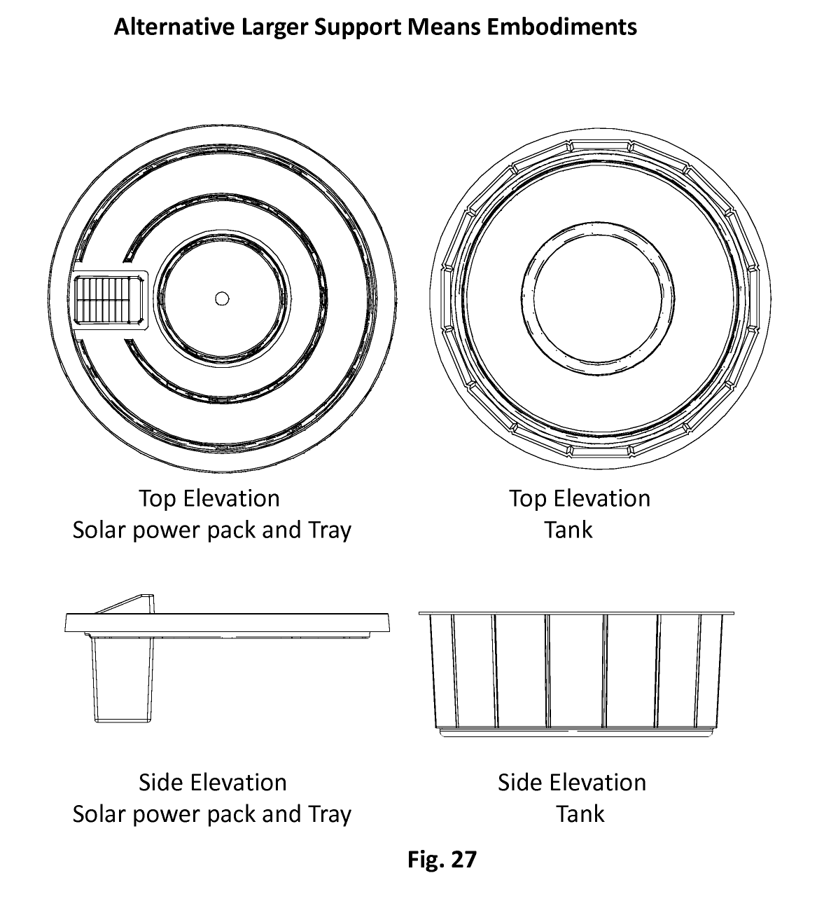

In said embodiment FIGS. 21 and 23 the base section may form a water storage reservoir (30) that is separated from a soil holding region by means of a separation plate or perforated grid FIG. 24 with excess drainage holes located above the uppermost tidal line of the water reservoir.

The separation plate or perforated grid has downward formed perforated depressions (42) that well down into the water reservoir extending the soil holding region within the perforated depressions and allowing water to enter the soil holding region but preventing the soil from entering the water reservoir region providing a self-watering effect on the soil holding region via the soils own capillary action on the fluid seepage through the perforations (43) in these downward depressions.

In yet another embodiment the water reservoir and separation plate are separate parts forming their own separate container FIG. 20 and are removable from the quarter section pot giving the user the choice of a self-watering option or a free draining option with the addition of extra drainage holes.

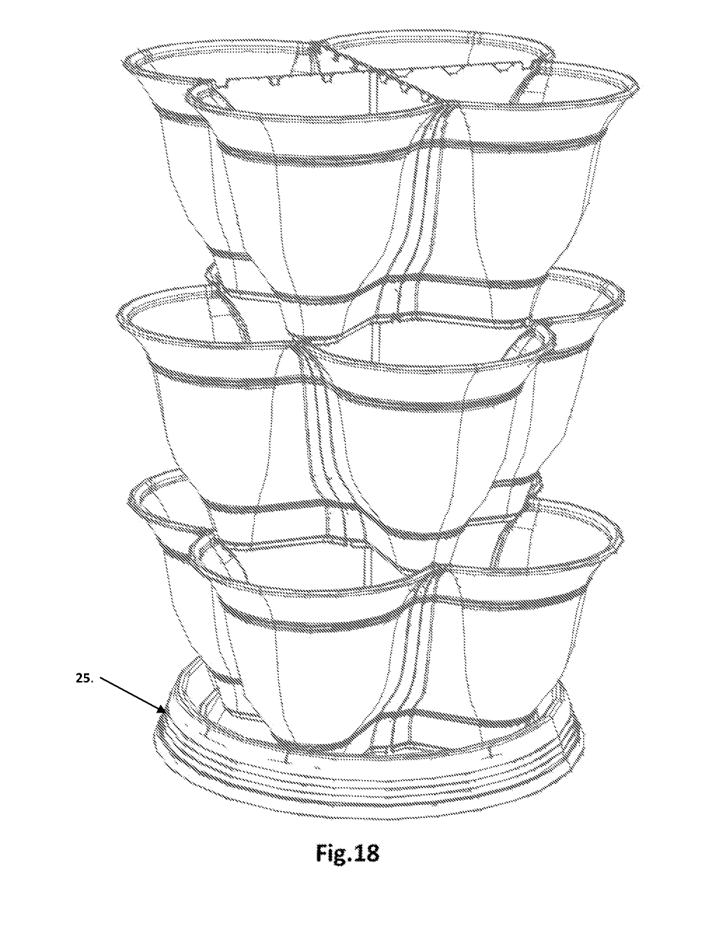

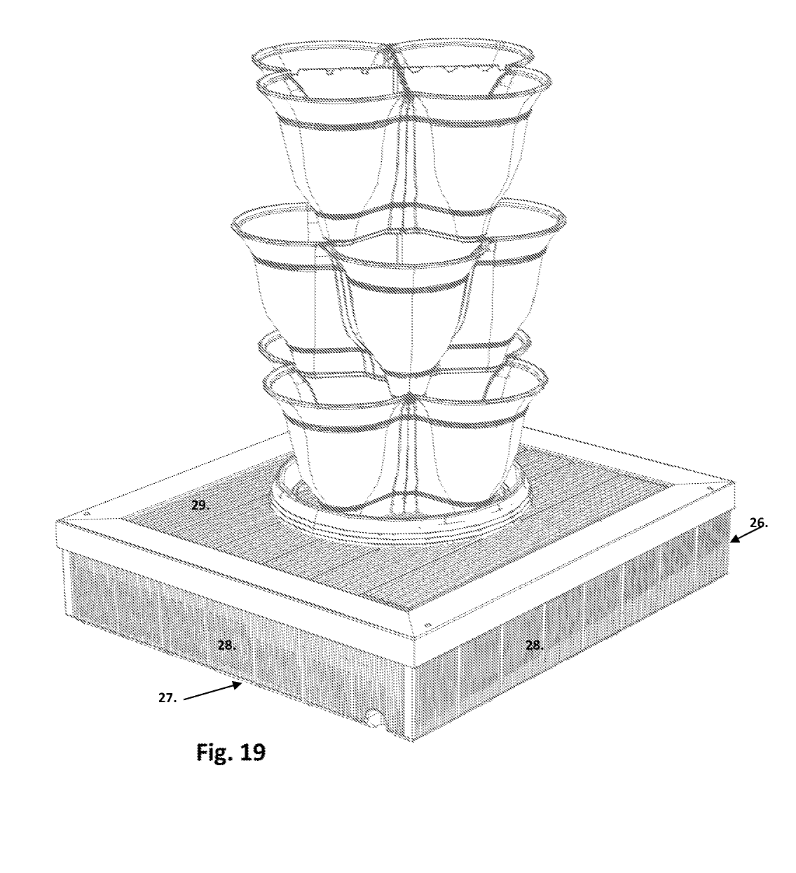

A coupled and or stacked formation of said quarter section pots may be provide with a support means in the form of a drainage overflow tray (25) FIG. 18 or saucer positioned under the lowermost pots of a coupled and or stacked formation with said tray or saucer having a raised centrally located opening allowing said elongated bodies to pass through from below its bottom surface while being shielded from any excess drainage held within the saucer. The coupled and or Stacked formation may be further provided with a larger support means (26.) FIG. 19 and seats over and upon a water or solution catchment tank or its drainage or feeding channels to facilitate an integrated hydroponics or aquaponics system incorporating mains powered, rechargeable battery powered and or solar assisted powered parts e.g. pump, timer oxygenator etc.

This water solution catchment tank or larger support means is a water storing plant growing container/s stand combination drainage tray modified to securely house and position a battery powered or assisted submersible pump or submersible pump with a perpetual movement or solar powered submersible pump within its reservoir area, comprising a bottom wall (27.) and a side wall/s (28.) and an opened cavity forming catchment tank that includes overflow drainage outlets passing through the said side wall/s at its upper region with both bottom and side walls supporting a water drainage tray (29.) spanning across its upper opening of its cavity and resting upon its upper edge, lip or step/s immediately above and adjacent to said side wall overflow drainage outlets and when in use provides a water storing self-reticulating watering system irrigating said supported plant growing container/s and may operate independently in any location without the requirement of mains power.

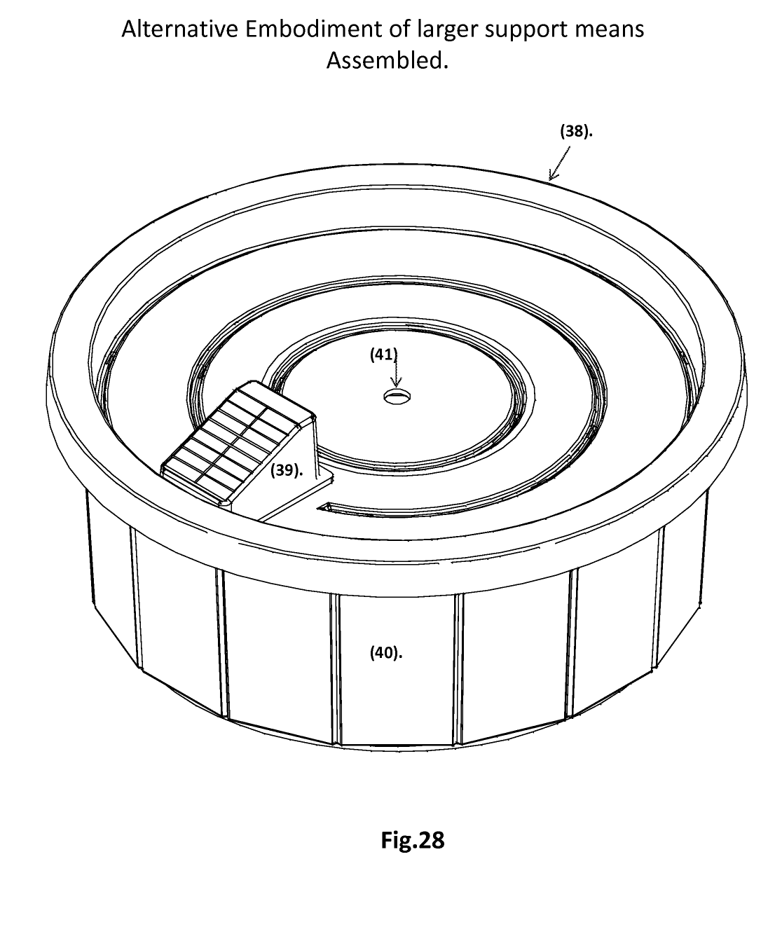

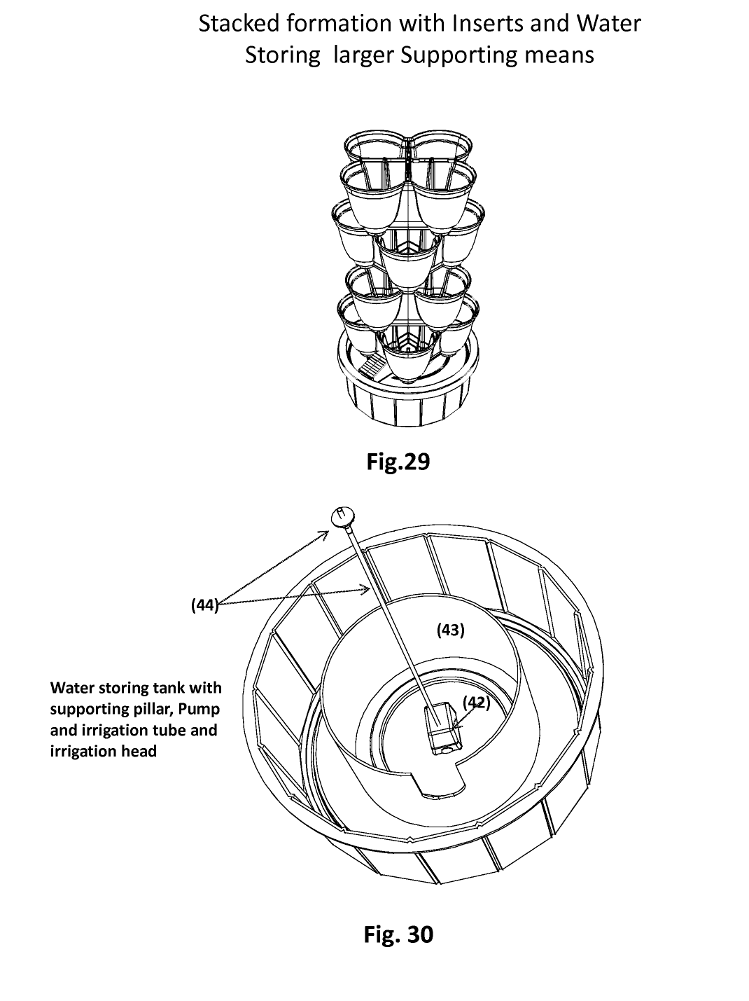

An embodiment of alternative water solution catchment tank or larger support means configured to support singular, grouped, stackable or vertical planting system containers has a tray FIG. 28/(38) modified to securely house and position a Power pack containing a rechargeable battery or a solar rechargeable battery, a solar cell for charging, a timer capable of collectively operating at preprogramed regulated cycles (39), a submersible pump or submersible pump (42) FIG. 30 with a perpetual movement within its reservoir area (40) which comprises a bottom wall and a side wall/s and an opened cavity forming a catchment tank that includes overflow drainage outlets passing through or over the said side wall/s at its upper region with both bottom and side walls supporting a perforated water drainage tray with an irrigation outlet (41) spanning across the upper opening of its cavity and resting upon its upper edge, lip, step/s and any form of internal supporting pillars (43) FIG. 30 immediately above adjacent to or in alignment with said side wall overflow drainage outlets and when in use provides a water storing regulated self-reticulating watering system irrigating a supported grouped or stacked formation of vertically positioned plant growing container/s operating independently at regulated intervals in any suitable plant growing environment without the requirement of mains power.

In another embodiment there is a centrally channelling drainage tray which has an orifice passing through its epicentre (41) in open communication with the tanks inner catchment area (40) FIG. 28 and large enough to allow channelled water to drain into the water storage catchment tank whilst upwardly passaging an irrigation hose and irrigation head (44) FIG. 30 through it from the battery powered or assisted submersible pump or submersible pump with a perpetual movement positioned in water storage catchment tank to the growing area of supported plant growing container/s to transport water stored in the water storage catchment tank upward to said growing areas when in operation.

Various features and advantages of the invention are set forth in the following claims:

1.-28. (canceled)

29. A Plant pot comprising:
a plurality of quarter sections operable to attach to each other and form a coupled layer having at least two quarter sections;
each of the plurality of quarter sections comprising
a base section,
an outwardly projecting front wall,
two side walls intersecting at a right angle, and
a cavity for the purpose of growing plants, the cavity defined by the base section, the outwardly projecting front wall, and the two side walls;
wherein each of the plurality of quarter sections is configured to mount to a corner between two vertical surfaces intersecting at an inward right angle;
wherein a first quarter section and a second quarter section are configured to form a coupled layer via a side wall of a first quarter section interlocking with a side wall of a second quarter section thus forming a coupled layer comprising an extended back wall and a central partitioned wall, the central partitioned wall comprised the interlocked side walls of the first quarter section and the second quarter section, wherein a coupled layer is configured to do at least one selected from the group consisting of mount to a vertical surface and stack on other coupled layers with an offset.

30. The plant pot according to claim 29, wherein a third quarter section is configured to interlock with a coupled layer, comprised of a first quarter section and a second quarter section, forming a 270° arrangement comprised of three quarter sections, the 270° arrangement configured to do at least one selected from the group consisting of mount to an outward projecting right angled corner and stack on other quarter sections or coupled layers with an offset.

31. The plant pot according to claim 29, wherein a coupled layer comprised of two quarter sections is configured to couple with a second coupled layer composed of two quarter sections, via interlocking an extended back wall of the coupled layer with an extended back wall of the second coupled layer, forming a 360° arrangement comprised of four quarter sections.

32. The plant pot according to claim 31, wherein the 360° arrangement comprised of four quarter sections is operable to be stacked on other quarter sections or 360° arrangements with an offset.

33. The plant pot according to claim 29, wherein each of the plurality of quarter sections can substantially nest or stack within a cavity of another quarter section.

34. The plant pot according to claim 29, wherein each of the plurality of quarter sections has a plurality of drainage overflow holes passing through the base section, an upper lip along the outwardly projecting front wall, and a plurality of overhanding tabs and a plurality of tab receiving bays along an upper edge of the two side walls.

35. The plant pot according to claim 34, wherein the first side wall of each quarter section has the plurality of overhanging tabs directing downward, the second side wall of each quarter section has the plurality of tab receiving bays directing upward, and wherein the tab receiving bays of the second side wall are operable to receive the overhanging tabs of the first side wall when a first quarter section is interlocked with a second quarter section.

36. The plant pot according to claim 29, wherein the base section of each of the plurality of quarter sections has a recessed bottom wall fitted with a locking mechanism, the locking mechanism comprised of a pair of elongated hooked barbs and a locking mechanism receiver, the locking mechanism receiver operable to interlock with the elongated hooked barbs of another quarter section.

37. The plant pot according to claim 36, further comprising a channel along the recessed bottom wall running from the intersection of the two side walls to the outwardly projecting front wall, the channel operable to sit on top of an upper edge of a coupled layer when in a stacked formation with an offset.

38. The plant pot according to claim 32, wherein the intersection of the two side walls of the quarter section forms a profiled channel running from the upper edge of the two side walls to the base section, wherein the 360° arrangement comprised of four quarter sections has a tube-like passage formed of the profiled channels, wherein an elongated body is able to pass through the tube-like passage, and wherein the elongated body is selected from the group consisting of a chain, a rope, a rod, a support, an irrigation tubing, and an irrigation equipment.

39. The plant pot according to claim 29, wherein the base section is fitted with a moisture retention device composed of a material selected from the group of super absorbing polymers, Perlite, Vermiculite, Zeolite, Coir, Sphagnum Moss, and sponge.

40. The plant pot according to claim 29, further comprising a bottom locking mechanism that is operable to attach a water reservoir region to the base section of each of the plurality of the quarter sections.

41. The plant pot according to claim 36, further comprising a recessed channel extending from the outwardly projecting front wall to the recessed bottom wall, the recessed channel forming a downwardly protruding lip on the outwardly projecting front wall that further comprises a plurality of notches configured to seat securely onto the upper lip of a quarter section positioned below in a stacked formation.

42. The plant pot according to claim 41, wherein the base section has a water storage reservoir that is separated from a soil holding region within the cavity by a separation means selected from the group consisting of a separation plate and perforated grid.

43. The plant pot according to claim 42, wherein the separation means has downward formed perforated depressions that well down into the water storage reservoir allowing water to enter the soil holding region but preventing the soil from entering the water storage reservoir.

44. The plant pot according to claim 42, wherein the water storage reservoir and separation means are separate from the quarter sections, the water storage reservoir and the separation means forming a separate container removable from the quarter section.

45. The plant pot according to claim 29, wherein a coupled layer has a drainage overflow tray under the base sections of the plurality of quarter sections, the drainage overflow tray having a raised centrally located opening.

46. The plant pot according to claim 29, wherein a coupled layer has a larger support positioned over at least one of a water catchment tank, a drainage channel, and a feeding channel to facilitate an integrated hydroponics incorporating powered parts selected from the group of a pump, a timer, an oxygenator, and a plurality of sensors.

47. The plant pot according to claim 46, wherein the larger support is a water reservoir housing a powered submersible pump, the water reservoir comprising a bottom wall, a plurality of side walls, and an opened cavity, the opened cavity forming a catchment tank that has overflow drainage outlets passing through the plurality of side walls, the plurality of side walls supporting a water drainage tray spanning across the opened cavity.

48. The plant pot according to claim 47, wherein the drainage tray is configured to direct water through at least one of a central location and a plurality of perforations in the plurality of side walls to the catchment tank for storing, and wherein the drainage tray is fitted with a removable sealable containment vessel that houses the solar cell, the battery, and the timer.

49. The plant pot according to claim 47, wherein the drainage tray has an orifice passing in open communication with the catchment tank, wherein the orifice allows water to drain into the catchment tank and upwardly passaging an irrigation hose, the irrigation hose transporting water from the catchment tank upward to the cavity of each of the plurality of quarter sections via operation of the powered submersible pump.

50. The plant pot according to claim 32, wherein the 360° arrangement comprised of four quarter sections has a profiled channel between the four quarter sections, the profiled channel operable to receive a chain, wherein the chain is operable to attach to a slotted disc positioned at the base of the 360° arrangement formation and thereby support the 360° arrangement formation in hanging position tethered to an overhanging structure.

51. The plant pot according to claim 1, wherein the two side walls have at least one opening operable to receive fastening equipment for the purpose of mounting the quarter section to the vertical surface.

52. The plant pot according to claim 40, wherein each of the plurality of quarter sections further comprise an insert pot that fits into the cavity of the quarter section, the insert pot comprising a detachable opening in a bottom wall to maximize moisture transfer from the water reservoir region of the quarter section to a soil holding region of the quarter section pot insert.
